(19) United States
(12) Patent Application Publication
(10) Pub. No.: US 2026/0189059 A1
(43) Pub. Date: Jul. 2, 2026

(54) BATTERY PACK MODULE, MULTI-BATTERY-PACK POWER SUPPLY SYSTEM, AND CONTROL METHOD

(71) Applicant: NANJING DMHC SCIENCE & TECHNOLOGY CO., LTD., Jiangbei New District Nanjing, Jiangsu (CN)

(72) Inventor: Min SUN, Jiangbei New District Nanjing, Jiangsu (CN)

(21) Appl. No.: 19/129,266

(22) PCT Filed: Nov. 16, 2023
(86) PCT No.: PCT/CN2023/132120

§ 371 Date: May 12, 2025

(30) Foreign Application Priority Data
Dec. 26, 2022 (CN) 202211676057.4

(51) Int. Cl. H02J 9/06; H01M 10/42; H01M 10/48

(52) U.S. Cl. CPC H02J 9/068; H01M 10/425; H01M 10/482; H01M 2010/4271

(57) ABSTRACT

Provided are a battery pack module, a multi-battery-pack power supply system, and a control method. The battery pack module comprises a battery pack, a switch unit, a control unit, a power supply circuit, a battery management unit, and a bus interface. The battery pack is connected to one end of the switch unit; the other end of the switch unit is used for connecting in parallel to another battery pack module; the battery pack is connected to the control unit by means of the power supply circuit; the battery pack is connected to the battery management unit; the battery management unit is connected to the control unit; the control unit is connected to the switch unit and the bus interface; and the bus interface is used for communicationally connecting to another battery pack module.

### CROSS-REFERENCE TO RELATED APPLICATION

The present disclosure claims the priority to the Chinese patent application No. 202211676057.4 filed on Dec. 26, 2022 with the Chinese Patent Office and entitled “BATTERY PACK MODULE, MULTI-BATTERY-PACK POWER SUPPLY SYSTEM, AND CONTROL METHOD”, the contents of which are incorporated herein by reference in entirety.

### TECHNICAL FIELD

The present disclosure relates to the technical field of electric-assisted bicycles, in particular to a battery pack module, a multi-battery-pack power supply system and a control method.

### BACKGROUND ART

With the development of electric-assisted bicycles, higher and higher requirements are put forward for the driving time of the driving system in electric-assisted bicycles. In order to prolong the service time of the driving system, it is necessary to make the battery power of electric-assisted bicycles larger.

In an electric-assisted bicycle, the power can be increased by assembling multiple battery packs, but after assembling the multiple battery packs, it is necessary to adopt a control device for the multiple battery packs to control the multiple battery packs. In the prior art, a voltage balancer is added between the multiple battery packs, and the voltage balancer is configured to detect the voltage or power of each battery pack, and then control one of the battery packs to carry out a load discharging in accordance with the voltage or power. However, the adoption of the voltage balancer increases hardware costs.

### SUMMARY

The objective of the present disclosure is to provide a battery pack module, a multi-battery-pack power supply system and a control method in response to the above-mentioned deficiencies of the prior art, so as to solve the technical problem of high cost when the battery information is detected through a voltage balancer for controlling the power supply of the battery pack in the prior art.

In order to achieve the above objective, the technical solution adopted by the examples of the present disclosure is as follows.

In the first aspect, a battery pack module is provided in the example of the present disclosure, the battery pack module includes a battery pack, a switch unit, a control unit, a power supply circuit, a battery management unit and a bus interface.

The battery pack is connected to one end of the switch unit, and the other end of the switch unit is configured to connect in parallel with other battery pack modules. The battery pack is further connected to the control unit through the power supply circuit to supply power to the control unit.

The battery pack is further connected to the battery management unit, and the battery management unit is further connected to the control unit, and the control unit is connected to the switch unit to control the on-off of the switch unit. The control unit is further connected to the bus interface, wherein the bus interface is configured to perform communication connection with other battery pack modules.

Optionally, the battery management unit includes a battery management chip and a load balancing circuit.

The battery pack is further connected to one end of the load balancing circuit, and the other end of the load balancing circuit is connected to the battery management chip, and the battery management chip is further connected to the control unit.

Optionally, the switch unit includes a first switch unit and/or a second switch unit.

The first switch unit is connected to the positive electrode of the battery pack, and the second switch unit is connected to the negative electrode of the battery pack.

In the second aspect, a multi-battery-pack power supply system is provided in the example of the present disclosure, which includes a plurality of battery pack modules electrically connected in parallel, and the plurality of battery pack modules are in communication connection through a bus interface.

The plurality of battery pack modules are configured to electrically connect electrical loads. The switch unit of the main battery pack module in the plurality of battery pack modules is in a closed state, and the switch unit in the standby battery pack module is in an open state.

Each battery pack module is the battery pack module described in any one of the first aspects.

In the third aspect, a control method of multi-battery-pack power supply is provided in the example of the present disclosure, which is applied to the control unit in a main battery pack module in the multi-battery-pack power supply system of the second aspect, and the method includes:
acquiring the voltage information of the main battery pack module;
determining a target standby battery pack module from the remaining standby battery pack modules if the voltage information meets a preset switching condition;
sending a switching request of the main battery pack to the target standby battery pack module to instruct the target standby battery pack module to control the switch unit to be in a closed state, so that the target standby battery pack module serves as a new main battery pack module, and
controlling the switch unit in the main battery pack module to be in an open state if receiving the confirming switching response message fed back by the target standby battery pack module.

Optionally, the step of determining the target standby battery pack module from the remaining standby battery pack modules includes:
determining the target standby battery pack module from the remaining standby battery pack modules according to the preset priority order of the standby battery pack modules.

Optionally, the method further includes:
re-determining the target standby battery pack module if the confirming switching response message fed back by the target standby battery pack module is not received within the first preset time after sending the switching request of the main battery pack.

Optionally, before obtaining the voltage information of the main battery pack module, the method further includes:
issuing a negotiation request of the main battery pack when the main battery pack module is connected to the communication bus corresponding to the bus interface, and controlling the switch unit in the main battery pack module to be in a closed state if the response message fed back by other battery pack modules is not received within a second preset time after the negotiation request of the main battery pack is issued.

Optionally, after controlling the switch unit in the main battery pack module to be in a closed state, the method further includes:
receiving the negotiation request of the main battery pack issued by a first standby battery pack module when the first standby battery pack module is connected to the communication bus; and
feeding back a response message of the existence of the main battery pack to the first standby battery pack module, and creating the preset priority order of the standby battery pack module. The switching request of the main battery pack includes the preset priority order of the standby battery pack modules.

Optionally, after creating the preset priority order of the standby battery pack modules, the method further includes:
receiving a negotiation request of the main battery pack issued by a second standby battery pack module when the second standby battery pack module is connected to the communication bus; and
feeding back a response message of the existence of the main battery pack to the second standby battery pack module, and updating the preset priority order of the standby battery pack module.

Compared with the prior art, the present disclosure has the following beneficial effects.

According to the battery pack module, the multi-battery-pack power supply system and the control method provided by the present disclosure, the battery pack module includes a battery pack, a switch unit, a control unit, a power supply circuit, a battery management unit and a bus interface, wherein the battery pack is connected with one end of the switch unit, and the other end of the switch unit is configured to connect in parallel with other battery pack modules. The battery pack is further connected with the control unit through the power supply circuit, so as to supply power to the control unit. The battery pack is further connected with the battery management unit, the battery management unit is further connected with the control unit, and the control unit is connected with the switch unit, so as to control the on-off of the switch unit. The control unit is further connected with the bus interface, wherein the bus interface is configured to perform communication connection with other battery pack modules. The control unit in the battery pack module communicates and interacts with other battery pack modules through the bus interface, to negotiate and determine the battery pack module to be switched, so that the control unit of the battery pack module to be switched controls the corresponding switch unit to close, thus completing the switching for the battery pack. Compared with the voltage balancer, the switching for the battery pack in the battery pack module of the present disclosure is realized through the communication interaction by the bus interface, which greatly reduces the hardware cost.

### BRIEF DESCRIPTION OF THE DRAWINGS

In order to more clearly illustrate the technical solutions of examples in the present disclosure, the drawing to be used in examples will be briefly introduced below. It should be understood that the following drawing only shows some examples of the present disclosure, so they should not be regarded as limiting the scope, for a person of ordinary skill in the art, other drawings can be obtained according to the drawing without inventive efforts.

FIG. 1 is a schematic structural diagram of a battery pack module provided by an example of the present disclosure.

FIG. 2 is a schematic structural diagram of another battery pack module provided by an example of the present disclosure.

FIG. 3 is a schematic structural diagram of another battery pack module provided by an example of the present disclosure.

FIG. 4 is a schematic structural diagram of a multi-battery-pack power supply system provided by an example of the present disclosure.

FIG. 5 is a schematic flowchart of a control method of the multi-battery-pack power supply provided by an example of the present disclosure.

FIG. 6 is a schematic flowchart of a method for confirming a main battery pack module provided by an example of the present disclosure.

FIG. 7 is a schematic flowchart of a method for creating the priority order of the standby battery pack modules provided by an example of the present disclosure.

FIG. 8 is a schematic flowchart of a method for updating the priority order of the standby battery pack modules provided by an example of the present disclosure.

FIG. 9 is a schematic diagram of a control device of a multi-battery-pack power supply provided by an example of the present disclosure.

FIG. 10 is a schematic diagram of a control unit provided by an example of the present disclosure.

Reference numerals: battery pack 10; switch unit 20; control unit 30; power supply circuit 40; battery management unit 50; bus interface 60; battery management chip 51; load balancing circuit 52; first switch unit 21; second switch unit 22; multi-battery-pack power supply system 1; battery pack module 100.

### DETAILED DESCRIPTION OF EMBODIMENTS

In order to make the objectives, technical solutions and advantages of the examples of the present disclosure more clear, the technical solutions in the examples of the present disclosure will be described clearly and completely with the drawings in the examples of the present disclosure below. Obviously, the described examples are a part of the examples of the present disclosure, but not the whole examples. The components of the examples of the present disclosure, which are generally described and illustrated in the drawings herein, can be arranged and designed in various configurations.

Therefore, the following detailed description of the examples of the present disclosure provided in the drawings is not intended to limit the scope of the claims in the present disclosure but only represents selected examples of the present disclosure. Based on the examples in the present disclosure, all other examples obtained by those skilled in the art without inventive work belong to the protection scope of the present disclosure.

Furthermore, if the terms such as “first”, “second” and “third” appear, they are configured to distinguish descriptions only and are not to be understood as indicating or implying relative importance.

It should be noted that, in the case of no conflict, the features in the examples of the present disclosure can be combined with each other.

Electric-assisted bicycles can be equipped with multiple battery packs to increase the power, wherein one battery pack supplies power to the driving system. In the prior art, it is costly to adopt a voltage balancer to detect the voltage or power of each battery pack and control the switching of a certain battery pack in multiple battery packs for load discharging. In order to solve the technical problem of high cost in the switching of battery pack, a battery pack module, a multi-battery-pack power supply system and a control method are provided in the present disclosure. The switching for battery packs is realized through the communication interaction among the battery packs, and compared with a voltage balancer, the hardware cost can be reduced.

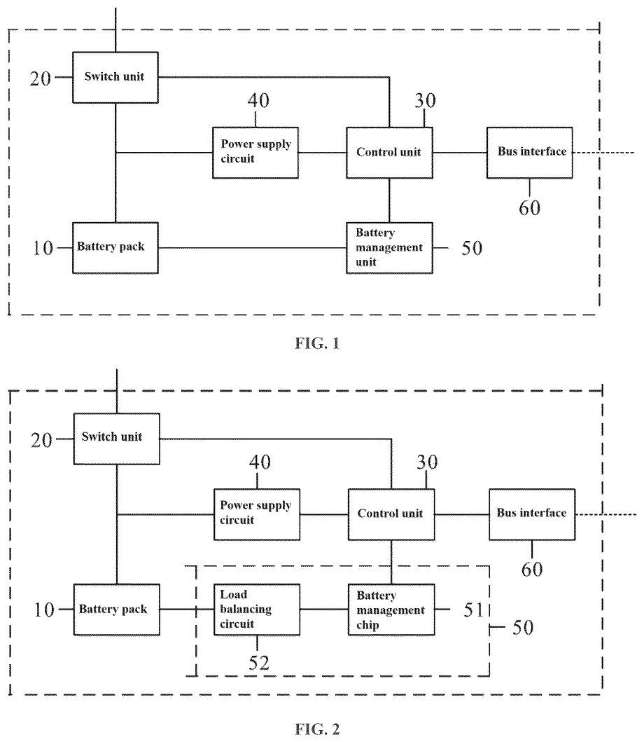

A battery pack module provided by an example of the present disclosure will be explained by specific examples as follows. FIG. 1 is a schematic structural diagram of a battery pack module provided by an example of the present disclosure. As shown in FIG. 1, the battery pack module includes a battery pack 10, a switch unit 20, a control unit 30, a power supply circuit 40, a battery management unit 50 and a bus interface 60.

The battery pack 10 is connected to one end of a switch unit 20, and the other end of the switch unit 20 is configured to connect in parallel with other battery pack modules. The other end of the switch unit 20 is the power output end of the battery pack, that is, the power supply end. After multiple battery packs 10 are connected in parallel, a total battery device in an electric-assisted bicycle composed of multiple battery packs can be formed. The total output end of the total battery device, that is, the total power supply end, can be obtained after multiple battery pack modules are connected in parallel. The power supply for each battery pack module can be controlled by the switch unit 20 in each battery pack module. When the switch unit 20 is in an open state, the battery pack module corresponding to the switch unit 20 cannot output electric energy, that is, it cannot supply power.

The battery pack 10 is further connected to the control unit 30 through a power supply circuit 40, so as to supply power to the control unit 30. The power supply circuit 40 can convert the voltage of the electric energy of the battery pack 10 into the voltage required for the operating of the control unit 30, so as to make the control unit 30 in an operating state.

The battery pack 10 is further connected to a battery management unit 50, and the battery management unit 50 is further connected to the control unit 30. The battery pack 10 can supply power to the battery management unit 50 to make the battery management unit in an operating state. The battery management unit 50 can collect information about the battery pack, and the control unit 30 can obtain the information collected by the battery management unit 50. In the example of the present disclosure, the battery management unit 50 can collect the voltage information of the battery pack 10 and transmit it to the control unit 30, so that the control unit 30 can monitor the electric quantity of the battery pack 10. For example, if the voltage information of the battery pack 10 is less than the preset voltage threshold, it means that the battery pack 10 has insufficient power.

The control unit 30 is connected with the switch unit 20 to control the on-off of the switch unit 20, so as to further control the output electric energy or power supply of the battery pack module.

The control unit 30 is further connected with a bus interface 60, and the bus interface 60 is configured for communication connection with other battery pack modules. The control unit 30 can communicate with other battery pack modules through the bus interface 60. In the example of the present disclosure, if the switch unit 20 is in the closed state and the control unit 30 obtains that the battery pack 10 has insufficient power, the control unit can communicate and negotiate with other battery pack modules through the bus interface 60 to determine a battery pack module that can continue to supply power, and then switch the power supply task to this battery pack module that can continue to supply power after determination, so that the control unit 30 in this battery pack module that can continue to supply power controls the switch unit 20 in this battery pack module that can continue to supply power to close. At the same time, the control unit 30 in the battery pack module with insufficient power controls the switch unit 20 in this battery pack module to open, thereby completing the switching of the battery pack module for power supply.

In the example of the present disclosure, the bus interface 60 can be a CAN (Controller Area Network) interface, and the bus interface 60 is configured to connect a CAN bus, so as to transmit communication data on the CAN bus.

Optionally, the control unit 30 can be a Microcontroller Unit (MCU) or other control units, which is not specifically limited in the example of the present disclosure.

Optionally, the control unit 30 can further be connected with a current sampling circuit, wherein the current sampling circuit is connected with the negative electrode of the battery pack and configured to collect the current values during charging or load discharging.

Optionally, the control unit 30 can further be connected with a temperature sampling circuit, and the temperature sampling circuit is close to the battery pack and configured to collect the temperature of the battery pack. When the temperature is too high, the control unit 30 records the temperature and the duration of the over-temperature.

Optionally, the power supply circuit 40 can further include a switch button, and by pressing the switch button, powering the control unit 30 with an operating voltage is realized.

According to the battery pack module provided by the present disclosure, the control unit in the battery pack module communicates and interacts with other battery pack modules through the bus interface, to negotiate and determine the battery pack module to be switched, so that the control unit of the battery pack module to be switched controls the corresponding switch unit to close, thus completing the switching for the battery pack. Compared with the voltage balancer, the switching for the battery pack in the battery pack module of the present disclosure is realized through the communication interaction by the bus interface, which greatly reduces the hardware cost.

Further, on the basis of the schematic structural diagram of a battery pack module shown in FIG. 1, a battery pack module is further explained through a possible implementation example of a battery management unit. Optionally, FIG. 2 is a schematic structural diagram of another battery pack module provided by the example of the present disclosure. As shown in FIG. 2, the battery management unit 50 includes a battery management chip 51 and a load balancing circuit 52.

The battery pack 10 is further connected to one end of the load balancing circuit 52, wherein the load balancing circuit 52 can collect the voltage information of each battery cell in the battery pack 10.

The other end of the load balancing circuit 52 is connected to the battery management chip 51, and the battery management chip 51 is further connected to the control unit 30. The battery management chip 51 can obtain the voltage information of each battery cell collected by the load balancing circuit 52, so that the control unit 30 can obtain the voltage information of each battery cell. The battery management chip 51 can further obtain the total voltage information of the battery pack 10 according to the obtained voltage information of each battery cell collected by the load balancing circuit 52, so that the control unit 30 can obtain the total voltage information of the battery pack 10.

In an implementation way, if the switch unit 20 is in the closed state, the control unit 30 can determine whether the voltage information of one battery cell less than the preset voltage of the battery cell exists according to the obtained voltage information of each battery cell. If it exists, it indicates that the battery pack has insufficiently power, and then the communication with other battery pack modules is conducted through the bus interface connected to the control unit 30, so as to switch the battery pack.

In another implementation way, if the switch unit 20 is in the closed state, the control unit 30 can determine whether it is less than the preset total battery voltage according to the obtained total voltage information of the battery pack 10. If the total voltage information of the battery pack is less than the preset total battery voltage, it indicates that the battery pack has insufficiently power, and then the communication with other battery pack modules is conducted through the bus interface connected to the control unit 30, so as to switch the battery pack.

Optionally, the battery management chip 51 can be O2MICRO battery management chip OZ8920TN, and can further be other battery management chips, which is not specifically limited in the example of the present disclosure.

In the example of the present disclosure, the power supply end of the battery management chip 51 can be directly connected with the battery pack 10, so that the battery pack 10 supplies power to the battery management chip 51.

According to the battery pack module provided by the example of the present disclosure, a battery management unit includes a battery management chip and a load balancing circuit, wherein the battery pack is further connected to one end of the load balancing circuit, and the other end of the load balancing circuit is connected to the battery management chip. The battery management chip is further connected to the control unit, so that the control unit can obtain the voltage information of the battery pack sequentially through the battery management chip and the load balancing circuit, so as to determine whether the battery pack needs to be switched according to the voltage information when the switch unit is closed.

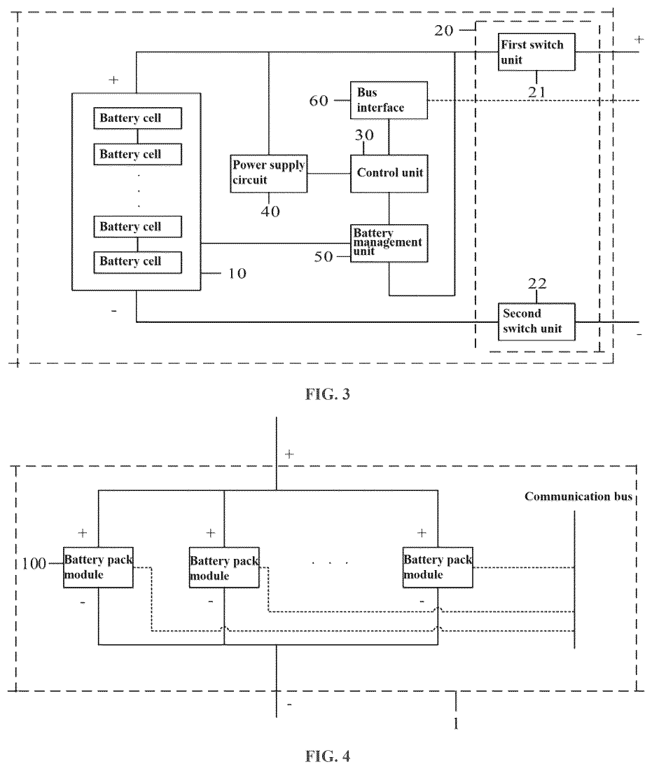

Further, on the basis of the above schematic structural diagram of a battery pack module shown in FIG. 1, the battery pack module is further explained through a possible implementation example of a switch unit. Optionally, FIG. 3 is a schematic structural diagram of another battery pack module provided by an example of the present disclosure. As shown in FIG. 3, the switch unit 20 includes a first switch unit 21, and/or a second switch unit 22.

The first switch unit 21 is connected to the positive electrode of the battery pack 10, and the second switch unit 21 is connected to the negative electrode of the battery pack 10.

If the switch unit 20 is in the closed state, when the voltage information of the battery pack obtained by the control unit 30 indicates that the power of the battery pack is insufficient, and after the switching of the battery pack 10 is performed, the control unit 30 disconnects the first switch unit 21, or disconnects the second switch unit 22, or disconnects both the first switch unit 21 and the second switch unit 22, so as to cut off the power supply of the battery pack module.

Optionally, the switch unit 20 can further include only the first switch unit 21, and after the switching of the battery pack 10 is performed, the control unit 30 disconnects the first switch unit 21.

Optionally, the switch unit 20 can further include only the second switch unit 22, and after the switching of the battery pack 10 is performed, the control unit 30 disconnects the second switch unit 22.

Optionally, the first switch unit 21 and the second switch unit 22 can be metal-oxide-semiconductor field-effect transistor (MOS transistor, MOSFET). The control unit 30 is connected to the pin of the first switch unit 21 or the pin of the second switch unit 22, when the pin is at a high level, the first switch unit 21 or the second switch unit 22 can be conducted, and when the pin is at a low level, the first switch unit 21 or the second switch unit 22 is disconnected.

According to the battery pack module provided by the example of the present disclosure, the switch unit includes a first switch unit and/or a second switch unit, wherein the first switch unit is connected to the positive electrode of the battery pack and the second switch unit is connected to the negative electrode of the battery pack. By controlling the conduction or disconnection of the first switch unit and/or the second switch unit through the control unit, the power supply control of the battery pack module is realized.

On the basis of the schematic structural diagram of the battery pack module shown in FIG. 1 to FIG. 3, a multi-battery-pack power supply system is further provided in the example of the present disclosure. Optionally, FIG. 4 is a schematic structural diagram of a multi-battery-pack power supply system provided by an example of the present disclosure. As shown in FIG. 4, the multi-battery-pack power supply system 1 includes multiple battery pack modules 100 electrically connected in parallel, wherein the multiple battery pack modules 100 are in communication connection through a bus interface 60.

After the positive electrodes of multiple battery pack modules 100 are electrically connected in parallel, a total positive electrode of power supply is obtained. After the negative electrodes of multiple battery pack modules 100 are electrically connected in parallel, a total negative electrode of power supply is obtained, and the total power supply end of the multi-battery-pack power supply system 1 is formed by the total positive electrode of power supply and the total negative electrode of power supply.

The multiple battery pack modules 100 are configured to electrically connect electrical load, wherein the total positive electrode of power supply and the total negative electrode of power supply are connected with an electrical load, so as to supply power to the electrical load.

The switch unit 20 in the main battery pack module of the multiple battery pack modules 100 is in the closed state, and the switch unit 20 in the standby battery pack module is in the open state, wherein the main battery pack module is the battery pack module that is supplying power to the electrical load, so the switch unit 20 of the main battery pack module is in the closed state. The standby battery pack module is other battery pack modules except the main battery pack module. Usually, when the main battery pack module supplies power, the standby battery pack module does not supply power, that is, when the electrical load is supplied with power, usually only one battery pack module is configured to supply power, which means that only one switch unit 20 is in the closed state. When the power of the main battery pack module that is supplying power is insufficient, a standby battery pack can be switched as a new main battery pack module to continue supplying power to the electrical load, so as to maintain the continuity of the power supply.

When the power of the main battery pack module that is supplying power is insufficient, the control unit 30 can issue a switching request of the main battery pack to a standby battery pack module that is communicatively connected with the communication bus through the bus interface 60. After communicating and interacting with a standby battery pack module through the communication bus, a standby battery pack can be adopted as a new main battery pack module, and its corresponding switch unit 20 can be closed, so as to continue supplying power to the electrical load through the new main battery pack module. At the same time, the control unit 30 of the original main battery pack module with insufficient power controls its corresponding switch unit 20 to open, thereby completing the switching of the battery pack module 100.

The multi-battery-pack power supply system provided in the present disclosure includes multiple battery pack modules electrically connected in parallel, wherein the multiple battery pack modules are in communication connection through bus interface, and the multiple battery pack modules are configured to electrically connect electrical loads. The switch unit in the main battery pack module in the multiple battery pack modules is in a closed state, and the switch unit in the standby battery pack module is in an open state. When the power of the main battery pack module is insufficient, through communication interaction among the battery pack modules, one standby battery pack module among multiple battery pack modules is switched as a new main battery pack module to continuously supply power to the electrical load. That is, the switching of the main battery pack module is realized through the communication interaction, without further adding hardware such as a voltage balancer, so as to reduce the hardware cost.

On the basis of the schematic structural diagram of a multi-battery-pack power supply system shown in FIG. 4, a control method of multi-battery-pack power supply is further provided in the example of the present disclosure. Optionally, FIG. 5 is a schematic flowchart of a control method of the multi-battery-pack power supply provided by an example of the present disclosure. As shown in FIG. 5, the method is applied to a control unit in a main battery pack module in a multi-battery-pack power supply system, and the method includes the following steps.

S501: Obtaining the voltage information of a main battery pack module.

When the main battery pack module is supplying power to the electrical load (the switch unit is closed), the control unit in the main battery pack module obtains the voltage information of the battery pack detected by the battery management unit in real time, so as to determine the electric quantity of the battery pack, wherein the voltage information can be the voltage information of each battery cell in the battery pack or the total voltage information of the battery pack.

Optionally, other information of the battery pack in the main battery pack module can be further obtained, as long as the other information can indicate the electric quantity of the battery pack.

S502: Determining a target standby battery pack module from the remaining standby battery pack modules if the voltage information meets a preset switching condition.

If the obtained voltage information of the main battery pack module is the voltage information of each battery cell, the preset switching conditions is that the voltage information of at least one battery cell is less than the preset voltage of the battery cell; and if the obtained voltage information of the main battery pack module is the total voltage information of the battery pack, the preset switching condition is that the total voltage information is less than the preset total battery voltage.

If the voltage information meets the preset switching conditions, that is, the main battery pack module has insufficient power and can no longer supply power to the electrical load, at this time, it can be switched to other battery pack modules to continue supplying power to the electrical load. Therefore, a target standby battery pack module that can supply power can be selected from the remaining standby battery pack modules except the main battery pack module, so as to continuously supply power to the electrical load through the target standby battery pack module.

S503: Sending a switching request of the main battery pack to the target standby battery pack module to instruct the target standby battery pack module to control the switch unit to be in a closed state, so that the target standby battery pack module serves as a new main battery pack module.

The control unit in the main battery pack module sends a switching request of the main battery pack to the target standby battery pack module through the communication bus, which is configured to switch the main battery pack module, that is, instructs that the target standby battery pack module controls the switch unit to be in the closed state, so as to serve as a new main battery pack module.

The switching request of the main battery pack is a point-to-point information, and the point-to-point information includes the identification of the main battery pack module, the identification of the target standby battery pack module and the switching information.

In the example of the present disclosure, the data frame structure of the point-to-point message corresponding to the point-to-point information can adopt a CAN extended frame structure, wherein the CAN extended frame structure includes a start segment (the beginning of the data frame), an arbitration segment, a control segment (indicating the reserved bits and the number of data bytes), a data segment, a CRC segment (configured for checking the transmission error of the frame), an ACK (an acknowledgement that the frame has been normally received) and an end frame (indicating the end of the data frame). The arbitration segment usually includes the information such as a source node ID, a target node ID, a command, and a data type to realize the communication interaction. The upper 28-24 bits in 29BIT of the arbitration segment of CAN extended frame structure can be defined as source ID (identification of the main battery pack module), 23-19 bits as target ID (identification of standby battery pack module), and the other parts of the bits can be configured to define battery pack for the interaction information and meaning. The data segment usually contains the data to be communicated, which can include the switching information, etc.

The identification of each battery pack module is unique and pre-configured. Moreover, it can further be adjusted as needed when the battery pack module changes.

S504: Controlling the switch unit in the main battery pack module to be in an open state if receiving the confirming switching response message fed back by the target standby battery pack module.

The target standby battery pack module is determined whether it can be adopted as the main battery pack module for power supply according to its power situation. If the target standby battery pack module is determined that it can supply power as the main battery pack module, it will send a confirming switching response message to the main battery pack module according to the switching request of the main battery pack sent by the main battery pack module, so as to instruct the main battery pack module that the target standby battery pack module can supply power as a new main battery pack module for the electrical load. At the same time, the control unit in the target standby battery pack module controls the corresponding switch unit to close to supply power to the electrical load, so as to serve as a new main battery pack module.

The confirming switching response message is a point-to-point message, and the point-to-point message includes the identification of the target standby battery pack module, the identification of the main battery pack module and the confirming switching information.

After the main battery pack module receives the confirming switching response message fed back by the target standby battery pack module, it confirms that the target standby battery pack module can be adopted as a new main battery pack module and controls the switch unit in the main battery pack module to be in the open state.

The control method of multi-battery-pack power supply is provided in present disclosure, which includes the following steps: obtaining the voltage information of a main battery pack module; if the voltage information meets a preset switching condition, determining a target standby battery pack module from the remaining standby battery pack modules; and sending a switching request of the main battery pack to the target standby battery pack module to instruct the target standby battery pack module to control a switch unit to be in a closed state, so as to serve as a new main battery pack module. If the confirming switching response message fed back by the target standby battery pack module is received, the switch unit in the main battery pack module is controlled to be in an open state. The switching of the main battery pack module is realized through communication interaction among the battery pack modules when the power of the main battery pack module is insufficient, so as to continuously supply power to the electrical load.

Further, on the basis of the control method of multi-battery-pack power supply shown in FIG. 5, a method for determining the target standby battery pack module is further provided in the example of the present disclosure. Optionally, the above method S502, determining the target standby battery pack module from the remaining standby battery pack modules, includes:
determining the target standby battery pack module from the remaining standby battery pack modules according to the preset priority order of the standby battery pack modules.

The control unit of the main battery pack module stores the preset priority order of the standby battery pack modules, and the stored data can be the priority order of the identifications of a plurality of standby battery pack modules.

When determining the target standby battery pack module, the standby battery pack module with the highest priority in the priority order can be selected as the target standby battery pack module.

The preset priority order of standby battery pack modules can be ranked and continuously updated by the time of accessing the communication bus, the priority can further be set according to the CAN communication, and the priority order can further be set by other means such as being user-defined, which is not specifically limited in the example of the present disclosure.

According to the method for determining the target standby battery pack module provided by the example of the present disclosure, the target standby battery pack module is determined from the remaining standby battery pack modules according to the preset priority order of standby battery pack modules, so that a target standby battery pack module with higher priority can be selected from a plurality of standby battery pack modules, and then the switching request of the main battery pack can be sent to the target standby battery pack module.

Further, on the basis of the control method of multi-battery-pack power supply shown in FIG. 5, another control method of multi-battery-pack power supply is further provided in the example of the present disclosure. Optionally, the above method further includes:
re-determining the target standby battery pack module if the confirming switching response message fed back by the target standby battery pack module is not received within a first preset time after sending the switching request of the main battery pack.

After the main battery pack module sends the switching request of the main battery pack to the target standby battery pack module, if the confirming switching response message fed back by the target standby battery pack module has not been received within the first preset time, the target standby battery pack module is not in a condition for power supply. Exemplarily, the power of the target standby battery pack module is also insufficient, and power supply is not allowed, or the target standby battery pack module has not been connected to the communication bus yet.

After the main battery pack module determines that the target standby battery pack module is not in a condition for power supply, it continues to re-determine the new target standby battery pack module. Exemplarily, a standby battery pack module with higher priority and not the original target standby battery pack module can be selected as the new target standby battery pack module according to the preset priority order of the standby battery pack module.

A switching request of the main battery pack is sent to the new target standby battery pack module to instruct the new target standby battery pack module to control the switch unit to be in a closed state, so as to serve as a new main battery pack module, and if a confirming switching response message fed back by the new target standby battery pack module is received, the switch unit in the main battery pack module is controlled to be in an open state.

According to the control method of multi-battery-pack power supply provided by the example of the present disclosure, if the confirming switching response message fed back by the target standby battery pack module is not received within the first preset time after the switching request of the main battery pack is sent, the target standby battery pack module is re-determined until a target standby battery pack module feeds back the confirming switching response message, so that the target standby battery pack module can be adopted as a new main battery pack module to supply power to the electrical load.

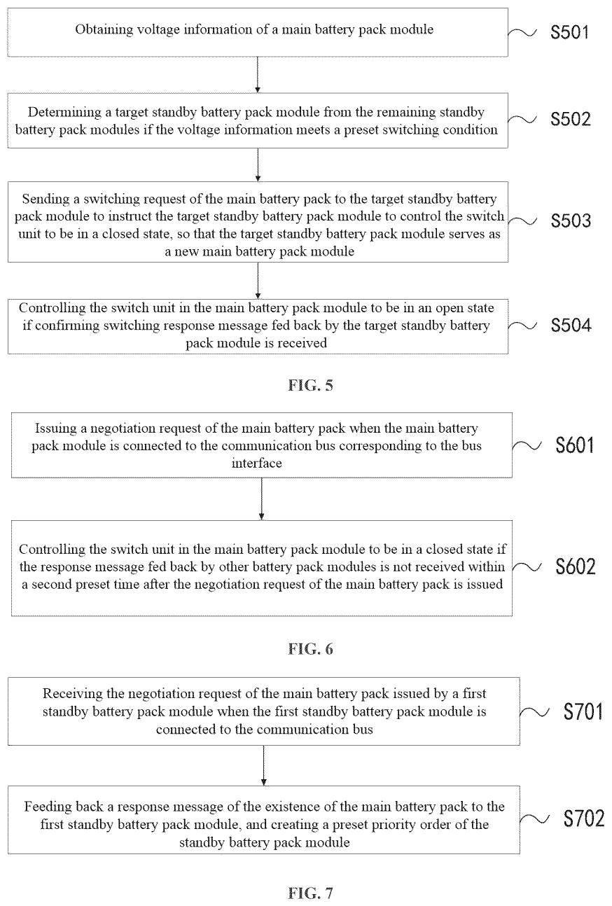

Further, on the basis of the control method of multi-battery-pack power supply shown in FIG. 5, a method for determining the main battery pack module is further provided in the example of the present disclosure. Optionally, FIG. 6 is a schematic flowchart of a method for confirming a main battery pack module provided by an example of the present disclosure. As shown in FIG. 6, before the above method S501, that is, before obtaining the voltage information of the main battery pack module, the method further includes:
S601: issuing a negotiation request of the main battery pack when the main battery pack module is connected to the communication bus corresponding to the bus interface.

When a battery pack module is connected to the communication bus corresponding to the bus interface (the battery pack supplies power to the control unit, the battery management unit and the bus interface, but the switch unit is not closed), a negotiation request of the main battery pack is periodically issued, wherein the negotiation request of the main battery pack is configured to confirm whether there is a main battery pack module supplying power to the electrical load.

The data message corresponding to the negotiation request of the main battery pack can be a published message or a point-to-point message. The data frame structure of the published message and the point-to-point message can both adopt the CAN extended frame structure.

Exemplarily, if the data message corresponding to the negotiation request of the main battery pack is a published message, the published message includes the identification of the battery pack module and the inquiry information of the main battery pack module. The published message can be sent to all battery pack modules on the communication bus.

Exemplarily, if the data message corresponding to the negotiation request of the main battery pack is a point-to-point message, the identifications of all battery pack modules that need to be connected to the communication bus are pre-stored within the battery pack modules, and the battery pack module generates a plurality of point-to-point messages to be sent to the corresponding battery pack modules based on the identifications of a plurality of battery pack modules that need to be connected to the communication bus in addition to the battery pack module itself. Each point-to-point message includes the identification of the battery pack module, the identification of each battery pack module except the battery pack module itself, and the query information of the main battery pack module. Each point-to-point message can be sent to the corresponding battery pack module.

S602: Controlling the switch unit in the main battery pack module to be in a closed state if the response message fed back by other battery pack modules is not received within a second preset time after the negotiation request of the main battery pack is issued.

If the battery pack module does not receive the response message from other battery pack modules within the second preset time after issuing the negotiation request of the main battery pack, it means that other battery pack modules are not connected to the communication bus yet, so the battery pack module can confirm that it is the main battery pack module and control the switch unit in the main battery pack module to be in the closed state, so as to supply power to the electrical load.

Optionally, the second preset time needs to be more than one cycle.

In the example of the present disclosure, the main battery pack module can be the battery pack module first connected to the communication bus, that is, the battery pack module first connected to the communication bus is the first main battery pack module.

According to the method for confirming the main battery pack module provided by the example of the present disclosure, when the main battery pack module is connected to the communication bus corresponding to the bus interface, the negotiation request of the main battery pack is issued. If the response message fed back by other battery pack modules is not received within a second preset time after the negotiation request of the main battery pack is issued, the switch unit in the main battery pack module is controlled to be in a closed state, so that the battery pack module first connected to the communication bus is the first main battery pack module.

Further, on the basis of the method for confirming the main battery pack module shown in FIG. 6, a method for creating the priority order of the standby battery pack modules is further provided in the example of the present disclosure. Optionally, FIG. 7 is a schematic flowchart of a method for creating the priority order of standby battery pack modules provided by an example of the present disclosure. As shown in FIG. 7, after the above method S602, that is, after the response message fed back by other battery pack modules is not received within a second preset time after the negotiation request of the main battery pack is issued, the switch unit in the main battery pack module is controlled to be in the closed state, the method further includes:
S701: receiving the negotiation request of the main battery pack issued by a first standby battery pack module when the first standby battery pack module is connected to the communication bus.

After the battery pack module first connected to the communication bus is adopted as the first main battery pack module, a new battery pack module is continuously connected to the communication bus, wherein the new battery pack module can be called the first standby battery pack module.

When the new battery pack module is connected to the communication bus, it will further periodically issue a negotiation request of the main battery pack to confirm whether there is a main battery pack module supplying power to the electrical load. At this time, the main battery pack module can receive the negotiation request of the main battery pack issued by the new battery pack module.

S702: Feeding back a response message of the existence of the main battery pack to the first standby battery pack module, and creating the preset priority order of the standby battery pack module.

After receiving the negotiation request of the main battery pack issued by the new battery pack module, the main battery pack module feeds back the response message of the existence of the main battery pack to the new battery pack module, indicating that the main battery pack module that is supplying power already exists on the communication bus.

The response message of the existence of the main battery pack is a point-to-point message, wherein the message corresponding to the point-to-point message includes the identification of the main battery pack module, the identification of the new battery pack module, and the information of the existence of the main battery pack.

After the new battery pack module receives the response message of the existence of the main battery pack, it recognizes itself as a standby battery pack module and does not close the switch unit of it.

After the main battery pack module feeds back the response message of the existence of the main battery pack to the first standby battery pack module, a preset priority order of the standby battery pack modules is created according to the identification of the first standby battery pack module in the negotiation request of the main battery pack issued by the first standby battery pack module. The preset priority order of the standby battery pack modules can be: main battery pack module>first standby battery pack module.

When the power of the main battery pack module is insufficient, according to the priority order, the standby battery pack module with the highest priority other than the main battery pack module is selected as the new main battery pack module, and at this time, the new main battery pack module can be the first standby battery pack module.

The switching request of the main battery pack includes the preset priority order of the standby battery pack modules, so that when the new main battery pack module has insufficient power, the priority order can be adopted as a condition or basis for determining the target standby battery pack module when switching battery pack module.

Specifically, when the power of the main battery pack module is insufficient, that is, when the voltage information of the main battery pack module meets the preset switching conditions, according to the preset priority order of the standby battery pack modules (main battery pack module>first standby battery pack module), the first standby battery pack module with the highest priority, which is not the main battery pack module, is selected as the target standby battery pack module, and a switching request of the main battery pack is sent to the first standby battery pack module. When the first standby battery pack module confirms that it can supply power according to its own power situation, it controls the switch unit in the first standby battery pack module to be in a closed state, so as to serve as a new main battery pack module. The switching request of the main battery pack includes a preset priority order of the standby battery pack modules, wherein the first standby battery pack module can store the preset priority order of the standby battery pack modules in the switching request of the main battery pack, so as to serve as a basis for selecting a target standby battery pack module when the battery pack module is switched due to the insufficient power of the first standby battery pack module. After the first standby battery pack module controls the switch unit to be in the closed state, it sends a confirming switching response message to the main battery pack module, and after the main battery pack module receives the confirming switching response message fed back by the target standby battery pack module, it controls the switch unit in the main battery pack module to be in the open state, so as to complete the switching for the battery pack module.

According to the method for creating the priority order of the standby battery pack modules provided by the example of the present disclosure, when the first standby battery pack module is connected to a communication bus, a negotiation request of the main battery pack issued by the first standby battery pack module is received, a response message of the existence of the main battery pack is fed back to the first standby battery pack module, and a preset priority order of the standby battery pack modules is created, so that when the power of the main battery pack module is insufficient, the target standby battery pack module is confirmed according to the preset priority order of the standby battery pack modules. The switching request of the main battery pack includes the preset priority order of the standby battery pack modules, so that after the target standby battery pack module is adopted as a new main battery pack module, the corresponding target standby battery pack module can be determined according to the priority order.

Further, on the basis of creating the priority order of the standby battery pack modules as shown in FIG. 7, a method for updating the priority order of standby battery pack modules is further provided in the example of the present disclosure. Optionally, FIG. 8 is a schematic flowchart of a method for updating the priority order of standby battery pack modules provided by an example of the present disclosure. As shown in FIG. 8, after the above method S702, that is, after creating the preset priority order of standby battery pack modules, the method further includes:
S801: receiving a negotiation request of the main battery pack issued by a second standby battery pack module when the second standby battery pack module is connected to the communication bus.

After the first standby battery pack module is connected to the communication bus, if the main battery pack module has not changed, when the new battery pack module is continuously connected, the new battery pack module can be called a second standby battery pack module.

When the new battery pack module is connected to the communication bus, it will also periodically issue a negotiation request of the main battery pack to confirm whether there is a main battery pack module supplying power to the electrical load. At this time, the main battery pack module can receive the negotiation request of the main battery pack issued by the new battery pack module.

S802: Feeding back a response message of the existence of the main battery pack to the second standby battery pack module, and updating the preset priority order of the standby battery pack modules.

After receiving the negotiation request of the main battery pack issued by the new battery pack module, the main battery pack module feeds back the response message of the existence of the main battery pack to the new battery pack module.

After the new battery pack module receives the response message of the existence of the main battery pack, it recognizes itself as a standby battery pack module and does not close the switch unit of it.

After the main battery pack module feeds back the response message of the existence of the main battery pack to the second standby battery pack module, the previously created preset priority order of the standby battery pack modules is updated according to the identification of the second standby battery pack module in the negotiation request of the main battery pack issued by the second standby battery pack module. If the previously created preset priority order of the standby battery pack modules is: main battery pack module >first standby battery pack module, the previously created priority order of the standby battery pack modules can be updated according to the time when the battery pack module is connected to the communication bus, wherein the updated priority order can be: main battery pack module >first standby battery pack module>second standby battery pack module.

When the power of the main battery pack module is insufficient, according to the priority order, the first standby battery pack module with the highest priority other than the main battery pack module is selected as the new main battery pack module, and at the same time, the priority order is sent to the new main battery pack module. If no new battery pack module is connected to the communication bus during the power supply by the new main battery pack module, the priority order will not be updated, and if there is a new battery pack module connected to the communication bus, the priority order will be updated. If the power of the new main battery pack module is insufficient, a battery pack module with the highest priority other than the new main battery pack module can be determined as the new main battery pack module according to the updated latest priority order.

Optionally, if a battery pack module is disconnected from the communication bus, the battery pack module in the latest priority order can be deleted, so as to improve the switching efficiency.

According to the method for updating the priority order of the standby battery pack modules provided by the example of the present disclosure, when the second standby battery pack module is connected to the communication bus, a negotiation request of the main battery pack issued by the second standby battery pack module is received, a response message of the existence of the main battery pack is fed back to the second standby battery pack module, and the preset priority order of the standby battery pack modules is updated, so that the priority order is continuously updated along with the connection of the battery pack modules to the communication bus, thus improving the flexibility of the control method of the power supply. At the same time, when the power of the main battery pack module is insufficient, the target standby battery pack module is determined according to the latest priority order of the standby battery pack modules.

The following describes a control device, a control unit and a storage medium of the multi-battery-pack power supply provided in the present disclosure, which are configured for implementation, wherein the specific realization process and technical effects thereof are described above and will not be repeated hereinafter.

FIG. 9 is a schematic diagram of a control device of a multi-battery-pack power supply provided by an example of the present disclosure. As shown in FIG. 9, the control device of a multi-battery-pack power supply includes:
an acquisition module 901, configured to acquire the voltage information of a main battery pack module;
a first determining module 902, configured to determine a target standby battery pack module from the remaining standby battery pack modules if the voltage information meets a preset switching condition;
a sending module 903, configured to send a switching request of the main battery pack to the target standby battery pack module, to instruct the target standby battery pack module to control the switch unit to be in a closed state, so as to serve as a new main battery pack module; and
a control module 904, configured to control the switch unit in the main battery pack module to be in an open state if receiving the confirming switching response message fed back by the target standby battery pack module.

Optionally, the first determining module 902 is specifically configured to determine the target standby battery pack module from the remaining standby battery pack modules according to the preset priority order of the standby battery pack modules.

A second determining module 905 is configured to re-determine the target standby battery pack module if the confirming switching response message fed back by the target standby battery pack module is not received within a first preset time after sending the switching request of the main battery pack.

Optionally, the acquisition module 901 is further configured to issue a negotiation request of the main battery pack when the main battery pack module is connected to the communication bus corresponding to the bus interface. If the response messages fed back by other battery pack modules are not received within a second preset time after the negotiation request of the main battery pack is issued, the switch unit in the main battery pack module is controlled to be in a closed state.

Optionally, the acquisition module 901 is further configured to receive the negotiation request of the main battery pack issued by the first standby battery pack module when the first standby battery pack module is connected to the communication bus, feed back a response message of the existence of the main battery pack to the first standby battery pack module, and create a preset priority order of the standby battery pack modules. The switching request of the main battery pack includes the preset priority order of standby battery pack modules.

Optionally, the acquisition module 901 is further configured to receive the negotiation request of the main battery pack issued by the second standby battery pack module when the second standby battery pack module is connected to the communication bus, feed back the response message of the existence of the main battery pack to the second standby battery pack module, and update the preset priority order of the standby battery pack modules.

The above modules can be one or more integrated circuits configured to implement the above methods, such as: one or more application specific integrated circuits (referred to as ASIC), or one or more microprocessors (digital signal processor, referred to as DSP), or one or more field programmable gate array (referred to as FPGA), etc. For another example, when one of the above modules is implemented in the form of a processing element scheduling program code, the processing element can be a general-purpose processor, such as a central processing unit (referred to as CPU) or other processors that can invoke the program code. For another example, these modules can be integrated and implemented in the form of system-on-a-chip (referred to as SOC).

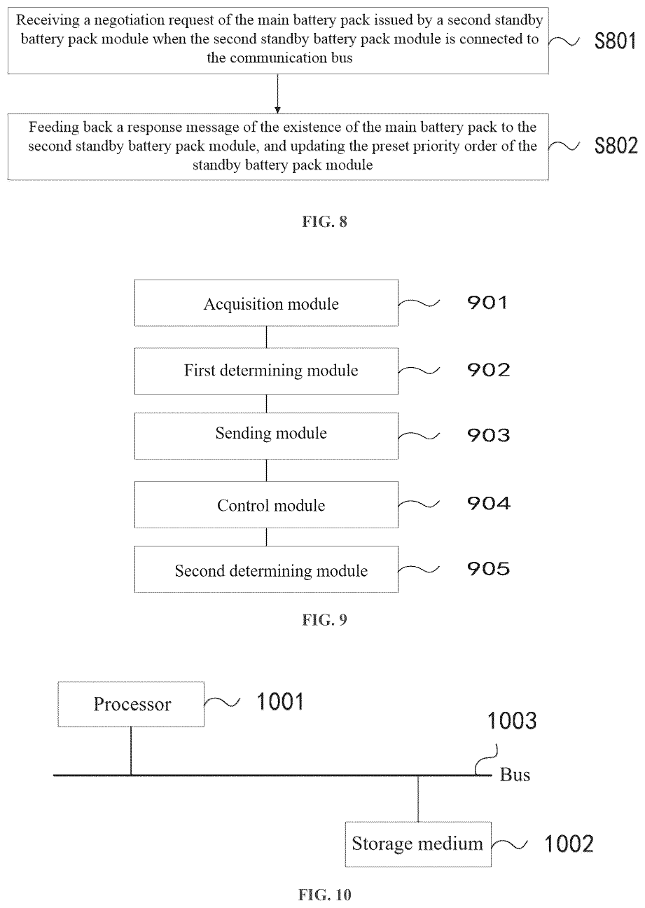

FIG. 10 is a schematic diagram of a control unit provided by an example of the present disclosure, and the control unit can be a device with a calculation processing function.

The control unit includes a processor 1001, a storage medium 1002 and a bus 1003, wherein the processor 1001 and the storage medium 1002 are connected by the bus 1003.

The storage medium 1002 is configured to store programs, and the processor 1001 invokes the programs stored in the storage medium 1002 to execute the methods provided in the above examples. The specific implementation methods and the technical effects are similar, and will not be described herein.

Optionally, a program product is further provided in the present disclosure, such as a computer-readable storage medium, including a program, which, when executed by a processor, is configured to perform the methods provided in the above-mentioned examples.

In several examples provided by the present disclosure, it should be understood that the disclosed devices and methods can be realized in other ways. For example, the example of the devices described above are merely illustrative; for example, the division of the units is merely a logical function division, wherein in actual implementation, there can be other division manners; for example, multiple units or components can be combined or integrated into another system, or some features can be ignored or not implemented. In addition, the mutual coupling, or direct coupling, or communication connection shown or discussed can be indirect coupling or communication connection through some interfaces, devices or units, which can be realized in electrical, mechanical or other forms.

The units described as separate components can or cannot be physically separated, and the components displayed as units can or cannot be physical units, that is, they can be located in one place or distributed to multiple network units. Some or all of the units can be selected according to actual needs to achieve the objectives of the solution of the present example.

In addition, each functional unit in each example of the present disclosure can be integrated into one processing unit, or each unit can physically exist separately, or two or more units can be integrated into a single unit. The above integrated units can be implemented in a form of hardware, or can be implemented in a form of a hardware plus software functional unit.

The above-mentioned integrated units realized in the form of software functional units can be stored in a computer-readable storage medium. The above software functional units are stored in a storage medium, and include several instructions to make a computer device (which can be a personal computer, a server, a network device, etc.) or a processor execute part of the steps of the method described in various examples of the present disclosure. The aforementioned storage mediums include: USB flash disk, mobile hard disk, read-only memory (ROM), random access memory (RAM), diskette or optical disk, or other kinds of medium that can store program codes.

The above is only the specific implementation of the present disclosure, however, the protection scope of the present disclosure is not limited thereto. Any changes or substitutions can be easily conceived of by those skilled in the art within the technical scope disclosed in the present disclosure, which should be covered within the scope of protection of the present disclosure. Therefore, the protection scope of the present disclosure should be subject to the protection scope of the claims.

### INDUSTRIAL PRACTICABILITY

To sum up, a battery pack module, a multi-battery-pack power supply system and a control method are provided in the present disclosure. The control unit in the battery pack module communicates and interacts with other battery pack modules through the bus interface to negotiate and determine the battery pack module to be switched, so that the control unit of the battery pack module to be switched controls the corresponding switch unit to close, thus completing the switching for the battery pack. Compared with the voltage balancer, the switching of the battery pack in the battery pack module of the present disclosure is realized through the communication interaction by the bus interface, which greatly reduces the hardware cost.

In addition, it can be understood that the battery pack module, the multi-battery-pack power supply system and the control method of the present disclosure are reproducible and can be utilized in various industrial applications. For example, the battery pack module of the present disclosure can be utilized in the technical field of electric-assisted bicycles.

1. A battery pack module, comprising a battery pack, a switch unit, a control unit, a power supply circuit, a battery management unit and a bus interface, wherein
the battery pack is connected to one end of the switch unit, and the other end of the switch unit is configured to connect in parallel with other battery pack modules; the battery pack is further connected to the control unit through the power supply circuit to supply power to the control unit; and
the battery pack is further connected to the battery management unit, and the battery management unit is further connected to the control unit, and the control unit is connected to the switch unit to control an on-off of the switch unit; the control unit is further connected to the bus interface; and the bus interface is configured to perform a communication connection with other battery pack modules.

2. The battery pack module according to claim 1, wherein the battery management unit comprises a battery management chip and a load balancing circuit; and
the battery pack is further connected to an end of the load balancing circuit, and the other end of the load balancing circuit is connected to the battery management chip, and the battery management chip is further connected to the control unit.

3. The battery pack module according to claim 1, wherein the switch unit comprises a first switch unit and/or a second switch unit, wherein
the first switch unit is connected to a positive electrode of the battery pack, and the second switch unit is connected to a negative electrode of the battery pack.

4. A multi-battery-pack power supply system, comprising multiple battery pack modules electrically connected in parallel, wherein the multiple battery pack modules are in a communication connection through a bus interface;
the multiple battery pack modules are configured to electrically connect an electrical load; a switch unit in a main battery pack module in the multiple battery pack modules is in a closed state, and a switch unit in a standby battery pack module is in an open state; and
each battery pack module is the battery pack module according to claim 1.

5. A control method of multi-battery-pack power supply, applicable to the control unit in the main battery pack module in the multi-battery-pack power supply system according to claim 4, and the method comprising:
acquiring a voltage information of the main battery pack module;
determining a target standby battery pack module from a remaining standby battery pack modules when the voltage information meets a preset switching condition;
sending a switching request of main battery pack to the target standby battery pack module to instruct the target standby battery pack module to control a switch unit to be in a closed state, so that the target standby battery pack module serves as a new main battery pack module, and
controlling the switch unit in the main battery pack module to be in an open state when receiving a confirming switching response message fed back by the target standby battery pack module.

6. The control method of multi-battery-pack power supply according to claim 5, wherein the step of determining a target standby battery pack module from remaining standby battery pack modules comprises:
determining the target standby battery pack module from the remaining standby battery pack modules according to a preset priority order of standby battery pack modules.

7. The control method of multi-battery-pack power supply according to claim 5, wherein the method further comprises:
re-determining the target standby battery pack module when the confirming switching response message fed back by the target standby battery pack module is not received within a first preset time after sending the switching request of main battery pack.

8. The control method of multi-battery-pack power supply according to claim 6, wherein before obtaining the voltage information of the main battery pack module, the method further comprises:
issuing a negotiation request of main battery pack when the main battery pack module is connected to a communication bus corresponding to the bus interface; and
controlling the switch unit in the main battery pack module to be in the closed state when a response message fed back by other battery pack modules is not received within a second preset time after the negotiation request of main battery pack is issued.

9. The control method of multi-battery-pack power supply according to claim 8, wherein after controlling the switch unit in the main battery pack module to be in the closed state, the method further comprises:
receiving the negotiation request of main battery pack issued by a first standby battery pack module when the first standby battery pack module is connected to the communication bus; and
feeding back a response message of existence of main battery pack to the first standby battery pack module, and creating the preset priority order of standby battery pack modules, wherein the switching request of main battery pack comprises the preset priority order of standby battery pack modules.

10. The control method of multi-battery-pack power supply according to claim 9, wherein after creating the preset priority order of standby battery pack modules, the method further comprises:
receiving the negotiation request of main battery pack issued by a second standby battery pack module when the second standby battery pack module is connected to the communication bus; and
feeding back the response message of existence of main battery pack to the second standby battery pack module, and updating the preset priority order of standby battery pack modules.
